(19) United States
(12) Patent Application Publication
(10) Pub. No.: US 2014/0096246 A1
(43) Pub. Date: Apr. 3, 2014

(54) PROTECTING USERS FROM UNDESIRABLE CONTENT

(71) Applicant: Google Inc., Mountain View, CA (US)

(72) Inventors: Michael Gerard Morrissey, Atlanta, GA (US); Richard Cannings, Santa Cruz, CA (US); Joseph Benjamin Gruver, Mountain View, CA (US); Angana Ghosh, Sunnyvale, CA (US); Jonathan Bruce Larimer, Roswell, GA (US); Andrew Devron Stadler, San Francisco, CA (US); Panayiotis Mavrommatis, Menlo Park, CA (US); Niels Holger Gerhard Konstantin Provos, Mountain View, CA (US); Adrian Ludwig, Atherton, CA (US)

(21) Appl. No.: 13/633,093

(22) Filed: Oct. 1, 2012

(51) Int. Cl. G06F 21/00

(52) U.S. Cl. 726/23

(57) ABSTRACT

Systems, methods, routines and/or techniques are described to protect users from undesirable content, for example, on an open platform. One or more embodiments may prevent the installation of an application package or warn a user if the application package may be undesirable (e.g., because it may contain malware). In one or more embodiments, a method may include receiving a first request to install an application package, and receiving and/or capturing metadata related to the application package. The method may include communicating a second request (e.g., including the metadata) to a remote server, such that the remote server can determine whether the application package may be undesirable. The method may include receiving a response from the remote server, where the response may indicate whether the application package may be undesirable, and initiating installation of the application package if the application package is determined to be safe and/or acceptable.

### FIELD

The present disclosure relates to protecting users from undesirable content, for example, malware and/or other undesirable applications, and more particularly to one or more systems, methods, routines and/or techniques to protect users from undesirable content on an open platform.

### BACKGROUND

Mobile devices such as smartphones have become more advanced. Some mobile devices incorporate a processor that runs computer code, including code that implements an operating system (OS). Some mobile devices are capable of running computer code that implements one or more applications. Some mobile devices are capable of downloading these applications from an application server. In some situations, these applications may contain malicious code and/or may operate in a manner that attempts to trick the user and/or these applications may be undesirable for various other reasons.

Further limitations and disadvantages of conventional and traditional approaches will become apparent to one of skill in the art, through comparison of such systems with some aspects of the present disclosure as set forth in the remainder of the present application and with reference to the drawings.

### SUMMARY

The present disclosure describes one or more systems, methods, routines and/or techniques to protect users from undesirable content (e.g., malware and/or other undesirable applications) on an open platform. The systems, methods, routines and/or techniques of the present disclosure allow users to freely use open platform devices while providing efficient, updated and minimally intrusive protection to such users and/or devices. The systems, methods, routines and/or techniques of the present disclosure may detect that applications or application packages are undesirable (e.g., because they include malware), for example, at the time of installation, and may prevent the installation of such applications or warn a user that such applications may be undesirable. The systems, methods, routines and/or techniques of the present disclosure may include communicating information to a remote server, for example, such that the remote server can analyze the information to determine whether the application may be undesirable, for example, because it may include malware. The information communicated to the remote server may include metadata, for example, information about the application (e.g., filename, size, etc.), information about the source of the application (e.g., a URL, IP address, etc.), information about another application that requested the installation of the application, and information about the device and/or OS on which the application may be installed. The remote server may perform various routines and/or comparisons using the metadata to efficiently and smartly detect whether the application and/or application package may be undesirable.

These and other advantages, aspects and novel features of the present disclosure, as well as details of an illustrated embodiment thereof, will be more fully understood from the following description and drawings. It is to be understood that the foregoing general descriptions are examples and explanatory only and are not restrictive of the disclosure as claimed.

### BRIEF DESCRIPTION OF THE DRAWINGS

Several features and advantages are described in the following disclosure, in which several embodiments are explained, using the following drawings as examples.

FIG. 1 depicts an illustration of a block diagram showing example components, connections and interactions of a network setup, where one or more embodiments of the present disclosure may be useful in such a network setup.

FIG. 2 depicts an illustration of an example mobile device or smartphone and various example pieces of code or functions that may run or execute on a mobile device or smartphone, according to one or more embodiments of the present disclosure.

FIG. 3 depicts an illustration of an example mobile device or smartphone and an example window and/or message that may display on the screen of a mobile device or smartphone, according to one or more embodiments of the present disclosure.

FIG. 4 depicts a flow diagram that shows example steps in a method to protect users from undesirable content, in accordance with one or more embodiments of the present disclosure.

FIG. 5 depicts a block diagram of an example data processing system that may be included within a mobile device or smartphone, according to one or more embodiments of the present disclosure.

### DETAILED DESCRIPTION

Various mobile devices are capable of downloading applications (or “apps”) from one or more application servers. Various mobile devices include an application “store,” i.e., an application or utility that users can use to browse, download and/or install applications. Some application stores include application management features, for example, features that allow a user to view installed applications, update applications and/or uninstall and/or delete applications. For various mobile devices, the creator of the operating system may create, approve and/or certify a particular application store as an approved utility for downloading safe applications. In this respect, in theory, a user may have a higher degree of confidence that an application that the user downloads from an approved application store is free of malware and is not otherwise suspicious. Various mobile devices and/or operating systems are “open platforms,” meaning that users may be free to download applications from sources or utilities other than an approved application store. In some situations, applications that users download from these alternate sources or utilities may be more likely to contain malware and/or be otherwise undesirable.

The present disclosure describes one or more systems, methods, routines and/or techniques to protect users from undesirable content (e.g., malware) on an open platform. The systems, methods, routines and/or techniques of the present disclosure allow users to freely use open platform devices while providing efficient, updated and minimally intrusive protection to such users and/or devices. The systems, methods, routines and/or techniques of the present disclosure may detect whether applications or application packages may be undesirable, for example, at the time of installation, and may prevent the installation of such applications or warn a user that such applications may be undesirable (e.g., because they contain malware). The systems, methods, routines and/or techniques of the present disclosure may include communicating information to a remote server, for example, such that the remote server can analyze the information to determine whether the application may be undesirable (e.g., because it includes malware). The information communicated to the remote server may include metadata, for example, information about the application (e.g., filename, size, etc.), information about the source of the application (e.g., a URL, IP address, etc.), information about another application that requested the installation of the application and information about the device and/or OS on which the application may be installed. The remote server may perform various routines and/or comparisons using the metadata to efficiently and smartly detect whether the application and/or application package may be undesirable.

The term malware stands for malicious software and may refer to any software or code within a software program designed to, without a user's conscious consent, infiltrate, damage, monitor (or other malicious action) a computing device. Examples of malware include viruses, spyware, clickbots, phishing attempts, fraudware, Trojan horses, rooting or any other malicious software and/or code. Although the present disclosure may describe one or more systems, methods, routines and/or techniques to protect users from malware, it should be understood that the various systems, methods, routines and/or techniques described herein may also be used to prevent the installation of other types of undesirable applications. As one example of an undesirable application that may not technically be thought of as malware, a software program or application may be pirated or counterfeited. Although such an application may not be harmful to a user's device, it may be harmful to the real and original developer, author and the like. As another example of an undesirable application that may not technically be thought of as malware, a software program or application may run or execute in a manner that drains the batter of a mobile device faster than a user would expect. In various embodiments of the present disclosure, if the undesirable application is noted and accounted for in the verification servers, the descriptions provided herein may apply likewise to these sorts of undesirable applications. Therefore, the use of the term “malware” throughout this disclosure should not be understood to limit these descriptions and/or embodiments.

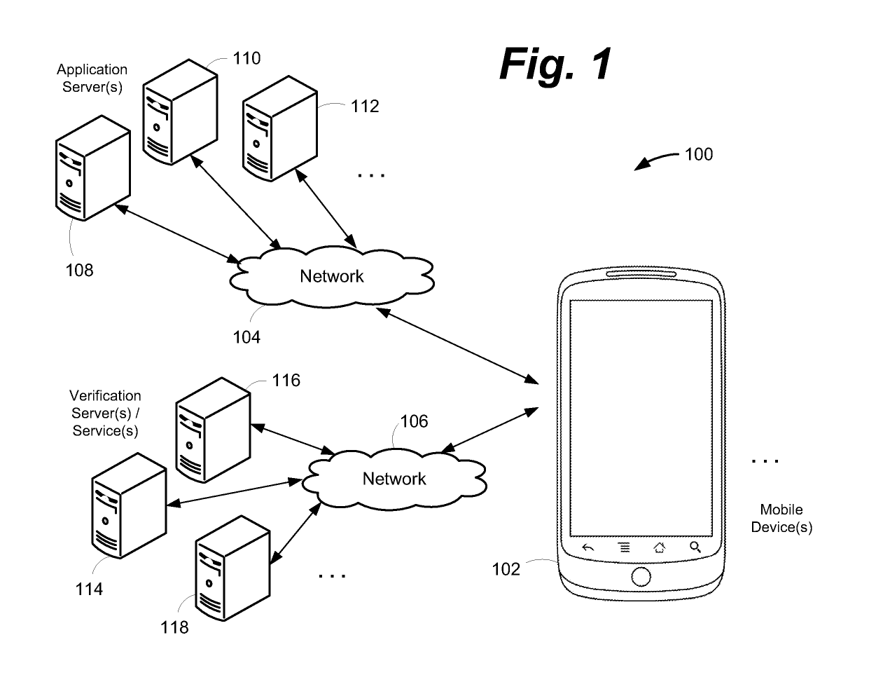

FIG. 1 depicts an illustration of a block diagram showing example components, connections and interactions of a network setup 100, where one or more embodiments of the present disclosure may be useful in such a network setup. It should be understood that the network setup 100 may include additional or fewer components, connections and interactions than are shown in FIG. 1. FIG. 1 focuses on a portion of what may be a much larger network of components, connections and interactions. Network setup 100 may include one or more mobile devices (for example, mobile device 102), one or more networks (for example, networks 104, 106), one or more application servers (for example, application servers 108, 110, 112) and one or more verification servers and/or services (for example, verification servers 114, 116, 118).

Networks 104 and 106 may be mediums used to provide communication links between various devices, such as data processing systems, servers, mobile devices and perhaps other devices. Networks 104 and 106 may include connections such as wireless or wired communication links. In some examples, networks 104 and 106 may represent a worldwide collection of networks and gateways that use the Transmission Control Protocol Internet Protocol (TCP IP) suite of protocols to communicate with one another. In some examples, networks 104 and 106 may include or be part of an intranet, a local area network (LAN) or a wide area network (WAN). In some examples, networks 104 and 106 may be part of the internet. In some examples, networks 104 and 106 may be part of the same network or group of networks.

Network setup 100 may include one or more mobile devices, for example, mobile device 102. The mobile device 102 of FIG. 1 is depicted as a smartphone, but the systems, methods, routines and/or techniques of the present disclosure may work with other mobile devices (e.g., cell phones, tablets, PDA's, laptop computers, etc.) or other computers or data processing systems in general. Various descriptions herein may reference hardware, software, applications and the like of mobile devices; however, it should be understood that the descriptions may apply to other devices and/or other computers, for example, any device that may download and/or install an application and/or software program. Mobile devices may communicate with application servers and/or content servers via one or more networks. Mobile devices may communicate with one or more application servers (for example, application servers 108, 110, 112), for example, to download applications or application packages. An application package may refer generally to a file format that may be used to distribute and install application software, for example, a file format designed for a particular operating system. Mobile devices may communicate with one or more verification servers and/or services (for example, verification servers 114, 116, 118), for example, to communicate information related to an application and/or application package to the verification servers for analysis, and to receive information from the verification servers regarding whether an application may be undesirable (e.g., because it may contain malware).

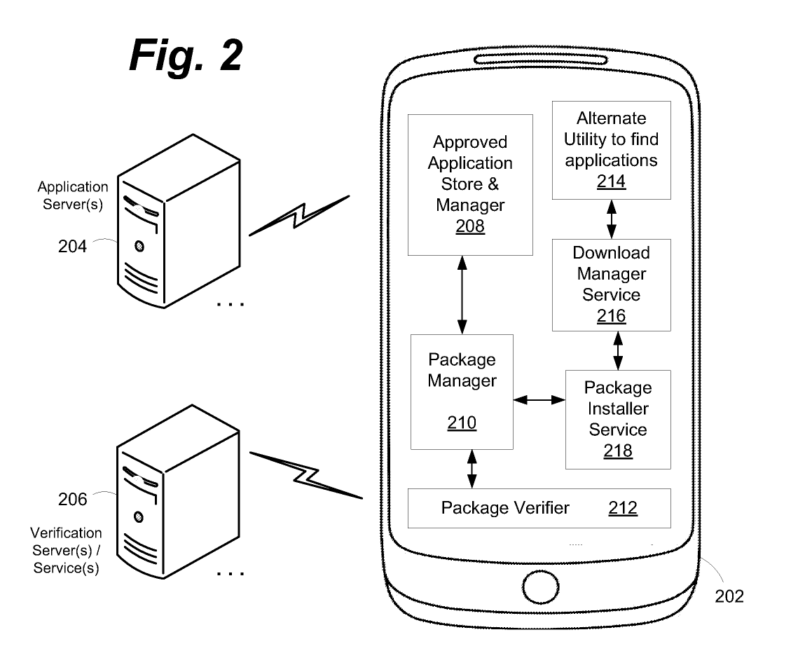

FIG. 2 depicts an illustration of an example mobile device or smartphone 202, according to one or more embodiments of the present disclosure. Mobile device 202 may be substantially similar to the mobile device 102 of FIG. 1, for example. Mobile device 202 may communicate with one or more application servers 204 and/or one or more verification servers and/or services 206. Mobile device 202 may incorporate a processor that runs or executes computer code, including code that implements an operating system (OS), other system code (i.e., code written by the creator of the smartphone and/or the operating system) and code developed by third parties (e.g., third party applications).

FIG. 2 depicts various example pieces of code or functions that may run or execute on mobile device 202. Mobile device 202 may include code related to an approved application store and/or manager 208. The approved application store and/or manager 208 may have been developed by the creator of the operating system and may be certified as an approved application or utility for downloading safe applications. The approved application store and/or manager 208 may communicate with one or more application servers 204, for example, to search for, browse and/or download applications and/or application packages. Mobile device 202 may include one or more alternate utilities 214 (e.g., a web browser or third-party application store) to find (e.g., search, browse, etc.) and/or initiate download of applications. These alternate utilities 214 may not be certified (e.g., by the creators of the operating system) and applications downloaded via these alternate utilities may be more likely to be undesirable (e.g., because they may contain malware). The alternate utilities 214 may communicate with one or more application servers 204, for example, to search for, browse and/or initiate installation of applications and/or application packages. Various embodiments of the present disclosure may be adapted to efficiently detect whether applications are undesirable (e.g., at the time of installation) regardless of the utility that was used to find and/or download the application. In this respect, various embodiments of the present disclosure may detect malware in applications that were downloaded via an approved application store and application that were downloaded via an alternate (e.g., uncertified) utility.

Mobile device 202 may include a package manager 210, which may be an application and/or service that runs on the mobile device. The package manager 210 may manage various aspects of installing an application and/or application package. The approved application store and/or manager 208 may communicate (e.g., directly or indirectly) with the package manager 210 to indicate and/or request that an application and/or application package should be installed. One or more alternate utilities 214 may communicate (e.g., directly or indirectly) with the package manager 210 to indicate and/or request that an application and/or application package should be installed. The package manager 210 may perform various checks (e.g., by communicating with one or more package verifiers 212) on an application and/or application package that is ready to be installed, for example, an application and/or application package that is stored (e.g., after being downloaded) on the mobile device 202. The package manager 210 may then install the application, for example, by reading, expanding and/or analyzing the application package.

Mobile device 202 may include various other services (e.g., applications, processes, etc.) that may aid in downloading and/or installing applications and/or application packages. For example, mobile device 202 may include a download manager service 216. The download manager service 216 may download one or more applications and/or application packages from one or more application servers. As another example, mobile device 202 may include a package installer service 218. The package installer service 218 may perform one or more initial checks on an application and/or application package (e.g., displaying permissions and/or security information), and then package installer service 218 may indicate and/or request that the application and/or application package should be installed.

In some embodiments, the download manager service 216 and the package installer service 218 may not be used when an application and/or application package is downloaded via approved application store and/or manager 208. In these embodiments, the approved application store and/or manager 208 may download an application and/or application package, optionally perform one or more initial checks, and indicate and/or request that the application and/or application package should be installed, for example, by communicating directly with the package manager 210. In some alternate embodiments, one or more other services may perform one or more operations between the approved application store and/or manager 208 and the package manager 210.

In some embodiments of the present disclosure, for example the embodiment of FIG. 2, the download manager service 216 and the package installer service 218 may be used when an application and/or application package is downloaded via an alternate utility 214. In these embodiments, the alternate utility 214 (e.g., a web browser or third-party application store) may allow a user to search for and/or browse for an application. The alternate utility 214 may then communicate with the download manager service 216, such that the download manager service downloads the application and/or application package. When the application and/or application package is downloaded, the download manager 216 (or the alternate utility 214) may communicate with the package installer 218 to indicate that an application and/or package is ready to be installed. The package installer service 218 may optionally perform one or more initial checks, and may then communicate with the package manager 210 to indicate and/or request that the application and/or application package should be installed.

Mobile device 202 may include one or more package verifiers 212. A package verifier 212 may be a first-party package verifier, meaning that it was created by the creators of the operating system. A package verifier 212 may be a third-party package verifier, meaning that it was created by a party other than the creators of the operating system. A package verifier may be a standalone application, process, service or the like. Alternatively, a package verifier may be incorporated into an application store and/or application manager, for example, the approved application store and/or manager 208. In the embodiments where a package verifier is incorporated into an application store and/or manager, the application store and/or manager may include and/or use a feature, service, API or the like that receives requests (e.g., from another app/service) to verify an application and/or application package. One example of such a feature, service, API or the like is a “broadcast receiver”. The feature, service, API or the like may listen for such verification requests, optionally perform a registration routine, optionally start the package verifier (e.g., though direct invocation), and communicate the request to the package verifier.

A package verifier 212 may include one or more system level processes that require particular permissions (e.g., root or OS-level permissions) to install and/or run. In this respect, in some embodiments, a package verifier may have to be installed and/or updated on the device when the device is sold or the package verifier may have to be installed and/or updated as part of an operating system update (e.g., an official OS release). For example, an official OS release may be installed on a mobile device via an over the air update (OTA) or may be installed in a device vendor store (e.g., by flashing the memory of mobile device). A package verifier 212 may be incorporated as part of the OS. This may result in benefits over various package verifier services that may operate as an application that may request information, access and the like from the OS. For example, a package verifier 212 incorporated as part of the OS, according to one or more embodiments of the present disclosure, may operate more efficiently and/or with more control over various processes and/or services that run on the mobile device 202. A package verifier 212 incorporated as part of the OS may operate closer to the applications and/or services that install applications, for example. Additionally, a package verifier 212 incorporated as part of the OS may be able to safely access OS level information that cannot be safely exposed to third-party package verifiers or detection services.

The package manager 210 may communicate with one or more package verifiers 212, for example, to perform various checks on an application and/or application package that is ready to be installed. The package manager 210 may communicate directly with a package verifier 212, or may communicate indirectly with the package manager 210 (e.g., via an application store and/or manager). The package manager 210 may communicate a request to a package verifier 212, for example, a request to analyze an application and/or application package to determine whether it may be undesirable (e.g., because it may include malware). The request may include various pieces of information, for example, information related to the application package (e.g., a hash or other unique identifier) and various pieces of metadata. The metadata may include information related to the application package (e.g., the package name, the size of the package, etc.), information related to the source of the application package (e.g., the download URL, the download IP address, etc.), information about another application that requested the installation of the application and/or information related to the device (e.g., device and/or OS versions) or the user of the device.

The request communicated from a package verifier 212 to a verification server 206 may include information related to the application package, for example, information that uniquely identifies the particular application and/or application package. In some embodiments, the request may include the application package file itself. In other embodiments, the request may include a unique value, string, series of characters or the like that uniquely identifies the application package (or identifies the application package with a very small possibility of error). This identifier may be calculated (e.g., in the package manager 210 and/or a package verifier 212) by reading data included in the application package and performing one or more algorithms, routines or the like on the data. One example of a unique identifier of an application package is a hash (e.g., SHA-256). A hash (or hash value) is a value, string, series of characters or the like generated by a function or algorithm that maps large data sets to smaller data sets, for example, with a fixed length. If a hash function is used to identify an application package, the chances that two application packages will map to the same hash value is extremely low. The request may include various other unique identifiers, signature or the like of the application package, for example, identifiers created by various cryptography algorithms. Two other example functions and/or algorithms that may be used to create a unique identifier are a probabilistic proof system and a zero knowledge proof system. In some embodiments, a hash function or other encryption function may only use a part of the application package data to create the unique identifier, for example, just the header of the application package. In some situations, using only part of the data may prevent a potential problem where changing one bit of the package data may change the unique identifier (hash, etc.) significantly.

In some embodiments of the present disclosure, the request communicated from a package verifier 212 to a verification server 206 may actually include multiple requests and/or response, for example, a series of request-response cycles. This multi-cycle request may be a “challenge response protocol.” For example, a package verifier 212 could communicate a first request to a verification server 206 to ask for a key, and the verification server could communicate a first response including a key. Then, the package verifier 212 (or related module or process) could encrypt the application package with provided key. Then, in a second request, the package verifier 212 could communicate to the verification server 206 the unique identifier (e.g., the encrypted package) and various other pieces of information, and the verification server could communicate a second response that indicates whether the application and/or application package may be undesirable (e.g., because it may contain malware).

The request may include various pieces of metadata. The term metadata may generally refer to “data about data,” meaning that metadata may refer to data that provides useful information (e.g., characteristics, contextual information, etc.) about another piece of data. As use in this disclosure, metadata may refer to data that provides useful information (e.g., characteristics, contextual information, etc.) about an application package. As one example, metadata may include information related to the application package file, for example, the package name, the size of the package, the creator of the package, a description or statement provided by the creator, what language the package is localized to and/or similar information. As another example, metadata may include information related to the source of the application package (e.g., from where the application package was downloaded), for example, the source or download URL, the source or download IP address and similar information. Another example of source metadata is “referrer” information, meaning information that shows how a user arrived at the URL where the application package was downloaded. For example, a referrer website may include a link that, when clicked on, directs a user to the URL/webpage where the user downloaded the application package. Referrer information may include more comprehensive information than just a single immediate referring website. For example, referrer information may extensive origination information and ancestry data, for example, large referral trees with multiple branches. In some embodiments, the term “social data” or social metadata may refer to various types of information that indicate information about people involved in the application, for example, who the application author is, what person and/or technology is responsible for placing the application on the device, etc.

As another example, metadata may include information related to the device (and/or the OS) on which the application may be installed, for example, the device make, model and/or version and/or the OS make, model and/or version. As another example, metadata may include information about one or more users of a device, for example, various pieces of information that a user has volunteered. As another example, metadata may include information about another application that requested the installation of the application. Additionally, it should be understood that information that uniquely identifies a particular application and/or application package (e.g., a unique identifier such as a hash or the like) may also be considered metadata.

In general, various types of metadata may be useful when detecting undesirable application (e.g., applications that may contain malware), for example, because various types of malicious code may be designed to target various types of devices, users, etc. As one example, various embodiments of the present disclosure may store and look for trends related to various types of metadata, for example, to detect and/or predict characteristics of malware attacks. In this respect, devices and/or users may be protected from malware attacks before it is too late. As another example, one or more embodiments of the present disclosure may utilize various routines, data stores and the like to take advantage of the realization that knowing who the creators/authors/distributors of undesirable application are may be even more useful than knowing exactly which application packages are undesirable.

It should be understood that various embodiments of the present disclosure may include various settings and/or options that protect the privacy of users, developers and the like. For example, a user may choose a setting that makes the device and/or the user anonymous when a request is communicated from the package verifier 212 to a verification server 206. As another example, a user, developer or administrator may choose whether a full application package is communicated as part of the request and/or which type of unique identifier of the package is communicated. For example, a hash value may provide more privacy to a user or developer because it does not include the actual data of the application package. As another example, the package verifier and/or the verification server(s) (e.g., both may be created and/or maintained by the same entity) may determine and/or implement settings and/or options that reduce a user's privacy exposure, for example, by reducing transmission of sensitive information. As one example, the package verifier or verification server(s) may identify specific hashes that are likely to be sensitive (e.g., some may relate known good apps and some may related to known bad apps) and the verification server may push these hashes to the device/package verifier, for example, for a local white list or black list comparison. In this respect, the verification service may avoid accessing and/or transmitting information that may be sensitive and is not required.

In various embodiments of the present disclosure, the unique identifiers, metadata and related information may be received, collected and/or captured by various routines, modules and/or applications that run on the mobile device 202. For example, an approved application store and/or manager 208 or an alternate utility 214 or the download manager 216 may be adapted to adapted to capture, download and/or collect metadata about the application package when the application package is downloaded, for example, the URL from where the application was downloaded and the name of the application and/or application package. As another example, metadata may be captured and/or collected from the protocol used to download the application package. For example, an HTTP protocol may include various pieces of information in the HTTP request and/or response, such as a referrer (e.g., “http referer”).

A package verifier 212 may communicate with the package manager, for example, to receive a request to analyze an application and/or application package that is ready to be installed. A package verifier 212 may receive a request that include various pieces of information, for example, the application package and various pieces of meta data, as explained in detail herein. A package verifier 212, for example, after receiving a request to analyze an application, may determine various additional pieces of information and/or metadata about the application package, its source, the device and/or a user. For example, a package verifier may determine the IP address of a download/source URL (e.g., by performing a DNS lookup). Alternatively, the IP address lookup may be performed in the package manager 210. A package verifier 212 may compute a hash (or other unique identifier associated with the application package). Alternatively, the hash and/or unique identifier may be calculated in the package manager 210.

A package verifier 212 may communicate with one or more remote (i.e., off-device) verification servers. A package verifier 212 may communicate information to the verification servers(s) related to an application and/or application package, and may receive information from the verification server(s) regarding whether the application and/or application package may be undesirable (e.g., may contain malware). A package verifier 212 may communicate a request to a verification server 206, for example, a request to analyze an application and/or application metadata and/or application package to determine whether it may be undesirable (e.g., because it may include malware). The request may include various pieces of information, for example, a hash (or other unique identifier) related to the application package and various pieces of metadata as explained in detail herein. For example, a request may include a hash, the source URL, the source IP address, the URL of the referrer (e.g., a webpage that directed a user to a download page), the referrer IP address and the location or address of one or more verification servers. A package verifier 212 may communicate a request to a verification server using various communication protocols, for example, an HTTP or HTTPS protocol. In some embodiments, the entire verification request or “payload” may be communicated to the server in a single “protocol buffer”. In other embodiments, the verification request may be communicated by multiple (e.g., a series) of requests.

A verification server 206 may receive a verification request from one or more mobile devices (e.g., mobile device 202). The verification server may use various pieces of information included in the request (e.g., a hash or other unique identifier related to the application package and various pieces of metadata as explained in detail herein) to determine whether the application and/or application package may be undesirable (e.g., because it may include malware). For example, the verification server may use information from a request such as a hash, the source URL from which the application package was downloaded, the source IP address, the URL of the referrer (e.g., a webpage that directed a user to a download page), the referrer IP address and optionally additional information.

In some embodiments, a verification server 206 may detect undesirable applications in an efficient manner, for example, by using various pieces of metadata (e.g., source URL, source IP address, etc.). Performing various checks using metadata may be more efficient than various other methods of detecting undesirable application (e.g., applications that include malware) that may perform comparisons between several hashes. For example, a verification server 206 may store information that indicates that a particular server/URL commonly hosts malicious content. A verification server 206 may efficiently determine whether a URL related to a verification request matches a stored malicious URL. Detecting undesirable applications using various pieces of metadata may provide other benefits. For example, because in some instances a hash may not be required to detect potential malware in an application and/or application package, in some embodiments, malware may be detected before an application package is downloaded form an application server. Even though various descriptions in the present disclosure describe package verification and/or verification at the point of application installation, it should be understood that verification and verification may be performed at various other steps in the process of downloading, installing and running applications.

A verification server 206 may include one or more data stores of information related to known undesirable application and/or known creators, authors, distributors and the like of undesirable applications. The data stores may include various pieces of information, for example, information identifying a particular application package (e.g., a hash or other unique identifier) and various pieces of metadata. A verification server 206 (or a related server or service) may accumulate, collect or aggregate this information related to known undesirable applications, for example, by analyze several cases over a longer period of time. For example, if a verification server 206 encounters an unknown (i.e., no match in the data stores) application package, hash, URL, IP address or the like, the verification server 206 (or a related server or service) may attempt to collect and/or store information about the application. For example, the verification server 206 may attempt to download the application package from a specified URL, for example, assuming that the URL is publicly accessible (e.g., not protected by access controls). The verification server 206 may then analyze the application and/or application package (e.g., by scanning the binary) to determine whether the application and/or application package includes any malicious code. If the application and/or application package is determined to include (or not include) malicious code, the verification server may store various information related to the application in the one or more data stores, for example, a hash of the application package, the source URL, etc.

In some embodiments, remote verification server 206 may perform various actions, tasks and/or routines when it encounters a piece of information that was not included in its various data stores. For example, if a verification request includes a URL that was not previously included in a remote verification server's data stores, the verification server may attempt to download the application package from the URL to analyze the binary. As another example action, a verification server may cause various other services to alter or update their behavior. For example, a verification server 206 may be maintained by the same entity that maintains various other services, for example, an approved application store and/or manager 208 and/or a search engine used to search the world wide web. As one specific example, if a new malicious application and/or application package is detected by the verification server 206, the verification server may cause a related approved application store and/or manager 208 to avoid listing the application as an optional download. As another specific example, if a new malicious URL is detected by the verification server, the verification server may cause a related search engine to avoid displaying search results that may lead a user to download applications, application packages and/or other software from the malicious URL. A verification server may perform various other actions, tasks and/or routines to protect users of computer, mobile devices and the like.

A verification server 206 may perform various routines and/or comparisons, for example, between information included in a verification request and information included in one or more data stores, to determine whether an application and/or application package may be undesirable (e.g., because it may include malware). For example, a verification server may maintain one or more lists and/or tables of hashes (or other unique identifiers) that are associated with known safe applications (e.g., a hash white list). As another example, a verification server may maintain one or more lists and/or tables of hashes (or other unique identifiers) that are associated with applications that are known to be undesirable (e.g., a hash black list). As another example, a verification server may maintain one or more lists and/or tables of source URLs and/or IP addresses that are known to provide safe applications (e.g., a source white list). As another example, a verification server may maintain one or more lists and/or tables of source URLs and/or IP addresses that are known to provide undesirable applications (e.g., a source black list). If a hash, URL, IP address or the like in a verification request matches a hash, URL, IP address or the like in one of white lists, a verification server may respond (e.g., to the requesting mobile device) that the application and/or application package is safe to install. If a hash, URL, IP address or the like in a verification request matches a hash, URL, IP address or the like in one of the black lists, a verification server may respond (e.g., to the requesting mobile device) that the application and/or application package should be prevented from installing. If a hash, URL, IP address or the like in a verification request matches no a hash, URL, IP address or the like in the data stores, a verification server may respond (e.g., to the requesting mobile device) that the application and/or application package may be undesirable (e.g., because it may include malware) and to proceed with caution.

In some embodiments, a verification server 206 may maintain one or more webs, networks or social graphs of information related to known undesirable applications, for example, known sources, authors, developers and/or distributors of malware. In this respect, a verification server 206 may detect potential or likely undesirable applications even if information included in a verification request (e.g., hash URL, IP address, etc.) does not exactly match information in one of the data stores. A verification server 206 may place importance on various pieces of social data like the authors and/or common providers of undesirable applications, for example, instead of just known malware infested applications and their immediate sources. As one example, a verification server 206 may determine with a fairly high degree of confidence that an application downloaded from a first server likely includes malware if the first server commonly communicates with a second server that commonly provides applications that include malware. After referencing this disclosure, it will also become apparent that a verification server 206 could detect additional levels of separation (e.g., larger social networks and/or webs of ancestry data), for example, a first server that communicates with a second server that communicates with a third server. As another example, an application may include a process and/or routine (e.g., a botnet) that frequently communicates with a server (e.g., a command and control server) that is known to instruct and/or collect information from malware. As another example, based on several positive detections of malware sourced from several related IP addresses, a verification server 206 may designate an entire pool of IP addresses and suspect sources. An application may be determined to potentially include malware if the application was downloaded from an IP address within a suspect pool, or if the source of the application (e.g., a server) commonly communicated with servers within this suspect pool. A verification server 206 may maintain various other types of suspect information associations.

The verification server 206 may remotely perform various checks for undesirable applications, meaning that various verification checks may be performed off of a mobile device, for example, in the cloud, one or more remote servers or the like. This remote maintenance of a verification server may offer various benefits. For example, the verification server 206, including the various data stores and detection routines, may be updated, for example, without requiring verification routines on the mobile device to change. As another example, various verification routines that were originally adapted to detect undesirable applications in software on desktop computers may be adapted to accept verification requests from mobile devices. As another example, remote maintenance of a verification server may allow an entity to maintain a live, updated and private collection of information and/or routines to check for undesirable applications. This may allow a mobile device to determine whether an application may be undesirable by receiving information about the most up-to-date known threats and/or risks. This may offer benefits over various other virus detection applications and the like that may maintain virus definition files, for example, on the mobile device or computer. In these cases, the virus definition files may need to be downloaded by the device or computer regularly, and even then, they may become stale by the time a particular application is being installed. Additionally, because these virus definition files may be released to the public, they may be exploited by hackers. A remote verification server may maintain its information and/or routines related to verification in private.

A verification server 206 may perform checks, routines and/or the like to prevent the leaking of the detection and/or verification information and/or routines that the verification server may use. For example, a verification server may check incoming verification requests to see whether they are likely to be coming from a legitimate mobile device or from an author of undesirable applications who is attempting to collect information about the verification service, for example, to design new malware to avoid the detection and/or verification routines. Based on these checks, the verification server may provide different responses. For example, if the verification server determines that the verification request is not from a legitimate device, it may return a response other than the responses discussed here, such as “SAFE,” “UNSAFE” or the like.

A verification server 206 may communicate with a mobile device 202 (e.g., the mobile device that transmitted a request to perform verification checks on an application package) to return various pieces of information. The information returned may depend on the outcome of various verification routines that were run on the verification server 206. A verification server may return various messages that may indicate whether an application and/or application package is safe to install. For example, if a verification server determines that the application package is safe or approved for installation, the verification server may return a message such as “OK,” “APPROVED,” “SAFE” or the like. The verification server may determine that an application is safe for installation for various reasons. For example, the verification server may have previously scanned the binary of the particular application and/or application package and determined that it contained no malware. As another example, the verification server may have determined (for example, based on accumulated information over time) that all known applications offered from a particular URL contain no malware. As another example message, if a verification server determines that the application package potentially unsafe or that caution should be taken at installation, the verification server may return a message such as “CAUTION,” “WARNING,” “POTENTIALLY UNSAFE” or the like. The verification server may determine that an application is potentially unsafe for installation for various reasons. For example, the verification server may have never encountered and/or scanned the binary of the application before. As another example, the verification server may have determined that the application was downloaded from a server/URL that distributes applications that are undesirable (e.g., because they contain malware). As another example message, if a verification server determines that the application package unsafe or that the application should not be allowed to install, the verification server may return a message such as “NOT OK,” “UNSAFE,” “MALICOUS CODE DETECTED” or the like. The verification server may determine that an application is unsafe for installation for various reasons. For example, the verification server may have previously scanned the binary of the particular application and/or application package and determined that it contained malware. As another example, the verification server may have determined (for example, based on accumulated information over time) that all known applications (or a high percentage) offered from a particular URL contain no malware.

A verification server may return various descriptions, for example, related to messages such as SAFE, UNSAFE and/or POTENTIALLY UNSAFE. The descriptions may be displayed to a user on the screen of the mobile device 202, for example, to provide the user with more information about why an application and/or application package is safe or unsafe to install. For example, if the verification server returns a SAFE message, it may or may not return a description. In some embodiments, a description may not be returned, for example, because the mobile device may install the application without interrupting the user. As another example, if the verification server returns an UNSAFE message, it may return a related description that explains why the application is unsafe, for example, a description of what the application may attempt to do (e.g., transmit the user's personal information to a remote server). As another example, if the verification server returns a POTENTIALLY UNSAFE message, it may return a related description that explains why the application may be unsafe, for example, a description that explains that the verification server has never seen this application package before.

A package verifier 212 may receive information from one or more one or more verification servers 206, for example, in response to a verification request. The information received from the verification server(s) may include various message and/or descriptions that indicate whether and/or why a particular application and/or application package is safe to install. For example, a verification server may communicate a message that the installation of an application should be allowed, denied, and/or whether a warning should be displayed related to the application. A package verifier 212 may handle and/or interpret these messages to determine whether to proceed with the installation of the application and/or application package. For example, if a package verifier 212 receives a message from a verification server that installation should be allowed (e.g., a SAFE message), the package verifier 212 may communicate with the package manager 210 to indicate that the application and/or application is verified for installation. As another example, if a package verifier 212 receives a message from a verification server that installation should be denied (e.g., an UNSAFE message), the package verifier 212 may communicate with the package manager 210 to indicate that the installation of the application and/or application should be denied and/or cancelled. As another example, if a package verifier 212 receives a message from a verification server that the application and/or application package may potentially be undesirable (e.g., a POTENTIALLY UNSAFE message), the package verifier 212 may communicate with the package manager 210 to indicate the same.

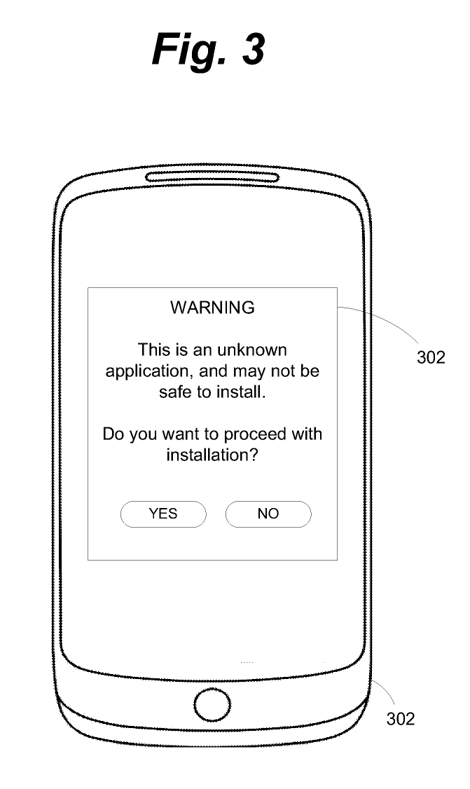

In the example where the application and/or application package is determined to be potentially unsafe, the package verifier 212 or the package manager 210 may cause a window and/or message to be displayed on the screen of the mobile device 202, for example, informing the user that the application may be undesirable (e.g., because it may contain malware), and asking the user if the user would like to proceed with installation. FIG. 3 depicts an illustration of an example mobile device or smartphone 302 and an example window and/or message 302 that may display on the screen of the mobile device, according to one or more embodiments of the present disclosure. As can be seen in FIG. 3, the window 302 may indicate a warning to a user, and may provide a brief description of why caution should be taken. For example, the description may say, “This is an unknown application, and may not be safe to install.” Another example description may say, “This application is not commonly downloaded and could be dangerous.” Various other descriptions are contemplated. The window 302 may include one or more buttons, links or the like that may allow a user to access more information about the application, for example, more information about why an application may be unsafe install. The window 302 may include a message that asks the user whether the user wants to proceed with installation, and may include one or more buttons (e.g., YES and NO buttons) that allow a user to indicate whether installation should proceed.

A package verifier 212 and/or package manager 210 may proceed with the installation of an application if a verification server does not respond in time (e.g., a failure or a network timeout). This may be referred to as a “default to allow” scheme. In this situation, the package verifier 212 may indicate to the package manager 210 that the application may be install, for example, communicating a similar message to the message that the package verifier 212 sends when an application package is determined to be safe (e.g., malware free). The embodiments where the package verifier 212 and/or package manager 210 allow installation in the situation of a timeout may be desirable in various situations. For example, if a goal of a verification scheme is to avoid interfering with a user's normal use, allowing installation may allow a user to continuing using the device with as little interruption as possible. The package verifier 212 and/or package manager 210 may include and/or reference a timeout value to determine how much time should pass before a timeout is declared. The timeout value may be configurable. As one example, a default timeout value may be set to 10 seconds, and the value may be changed, for example, by a user and/or administrator. A package verifier 212 and/or package manager 210 may proceed with the installation of an application if the mobile device 202 indicates that it does not have internet connectivity. If a device does not have internet connectivity, a timeout is likely, and the package verifier 212 and/or package manager 210 may proceed with the installation of an application in this situation.

In other embodiments, the package verifier 212 and/or package manager 210 may prevent and/or delay installation of a package if a verification server does not respond in time. This may be referred to as a “default to deny” scheme. In this situation, the package verifier 212 may ensures that the device never installs an unsafe application or one that has not been verified. In other embodiments, the package verifier 212 may include and/or implement multiple default or timeout verification schemes, for example, some that are “default to accept” and some that are “default to deny,” for example, based on the types of checks the package verifier is performing.

Mobile device 202 may include, access and/or maintain one or more white lists and one or more black lists. A white list may refer to information (e.g., stored locally on the mobile device) that may indicate that an application and/or application package is safe to install. A black list may refer to information (e.g., stored locally on the mobile device) that may indicate that an application and/or application package is not safe to install. Black lists and/or white lists may include various types of information, for example, information identifying particular application packages (e.g., hashes or other unique identifiers) and various pieces of metadata (e.g., source URLs, source IP addresses, etc.). The package verifier 212 and/or package manager 210 may perform various queries and/or comparisons between an application and/or application package and one or more of the white lists and/or black lists. Based on these queries and/or comparisons, the package verifier 212 and/or package manager 210 may determine that an application and/or application package is safe or unsafe to install. The various comparisons may be similar to some comparisons and/or routines that are performed on a verification server 206. For example, if a white list includes a source URL (e.g., indicating that this source offers safe applications), the package verifier 212 and/or package manager 210 may determine that an application downloaded from the same source/URL is safe.

In some embodiments, mobile device 202 may maintain one or more webs, networks or social graphs of information related to known undesirable applications, for example, known sources, authors, developers and/or distributors of malware, for example, similar to the webs, networks or social graphs explained with regard to the verification server. These webs, networks or social graphs may be used in a similar manner to a white list and/or black list to determine on the mobile device whether an application may be undesirable. These webs, networks or social graphs may be created on the mobile device or created on a remote server and pushed to the mobile device.

The package verifier 212 and/or package manager 210 may utilize various local black lists and/or white lists to enhance the performance of verification and/or to increase the privacy of users. Regarding performance, if the package verifier 212 and/or package manager 210 can determine that an application is safe or unsafe based on a local comparison, the package verifier 212 may not have to formulate and/or communicate a network request to a remote verification server 206, Avoiding such a network request may save time and/or resource on the mobile device 202. Therefore, in some embodiments of the present disclosure, the package verifier 212 may omit communicating with a verification server if appropriate information is found in one or more local white lists and/or black lists. Regarding privacy, if the package verifier 212 and/or package manager 210 can determine that an application is safe or unsafe based on a local comparison, the package verifier 212 and/or package manager 210 may avoid communicating information to a remote server, information such as the identity of the application, its source, and the like.

One or more embodiments of the present disclosure may include various options and/or settings that may enable or disable various features described herein. For example, users may change these options and/or settings via a settings page related to various operating system settings, e.g., if the package verifier is incorporated as part of the OS. As another example, users may change these options and/or settings via a settings page related to an application, e.g., if the package verifier is incorporated as part of an approved application store and/or manager, or if the package verifier is a standalone application. One example option and/or setting may allow a user to disable the verification process during the installation of the application. If this option and/or setting is set, the package verifier 212 may perform no functions, and the package manager 210 may not communicate any verification requests to the package verifier 212. In this respect, in some embodiments, if this option and/or setting is set, the majority or all of the various verification routines described herein may not be performed on the mobile device 202. In some situations, this option and/or setting may be used by a user to increase the user's privacy, for example, because the package verifier will not analyze any downloaded application packages, and, for example, the mobile device may not communicate any information regarding applications to a remote server. A user may be informed, however, that applications that the user installs may not be analyzed as thoroughly as they could be if the features described herein were enabled.

As another example, various option and/or setting may allow a user to disable the verification process with respect to particular application and/or with respect to particular groups of applications. These options and/or settings may disable verification checks as described above, but only for particular (e.g., specified) applications and/or groups of applications. Alternatively, the default option and/or setting may be to disable verification checks for all applications except for particular (e.g., specified) applications and/or groups of applications. These options and/or setting may be useful, for example, to developers of applications. Developers of applications may engage in a series of development cycles, for example, where the cycle includes updating application code, pushing the updated application to a test device, testing the application, and optionally, repeating the cycle. In these situations, a developer may know that the application that is safe, for example, because the developer created the application. Therefore, it may be beneficial to the developer to avoid additional verification checks that may slow down the development cycle. A developer may change the options and/or settings described above to disable verification checks for a particular application (e.g., the application currently being tested) or for a particular group of applications (e.g., all applications created by the developer's development tools).

One or more embodiments of the present disclosure may require confirmation and/or acceptance from a user before various features described herein are activated. For example, the first time the user engages with an application and/or service that may perform verification checks (e.g., using the package verifier 212), the user may be presented with a dialog. The dialog may include a message (e.g., terms of service) that explain to the user various aspects of enabling the verification feature and/or related features. The dialog may display options to the user, for example, allowing the user to accept and/or confirm that the feature(s) may be enabled. The user's decision may be stored, and the user may not see a similar message in the future. The dialog may be displayed to the user at various times and related to various applications and/or services. For example, the dialog may be incorporated into a larger general terms of service (TOS) of a larger application, for example, the approved application store and/or manager 208. In this example, when the user accepts the general terms of service, the user may accept and/or confirm that verification should be activated. In another example, even if the verification is incorporated into a larger application, the dialog may not display until the verification processes are about to be used (e.g., when a request is about to be sent to the package verifier). In this respect, the dialog and/or confirmation may be feature-specific.

One or more embodiments of the present disclosure may acceptance signals from a remote source (e.g., a remote server) that updates mobile device settings remotely. For example, a remote server may communicate a wireless signal to a mobile device indicating that various settings, flags, bits, configuration values and the like should be changed on the mobile device. In this respect, various options and/or settings as explained about (e.g, disabling verification) may be set via wireless communication with a remote server. In some embodiments, this remote configuration ability may be disabled by a user.

Certain embodiments of the present disclosure may be found in one or more methods to protect users from undesirable content, for example, on an open platform. With respect to the various methods described herein and depicted in associated figures, it should be understood that, in some embodiments, one or more of the steps described and/or depicted may be performed in a different order. Additionally, in some embodiments, a method may include more or less steps than are described and/or depicted.

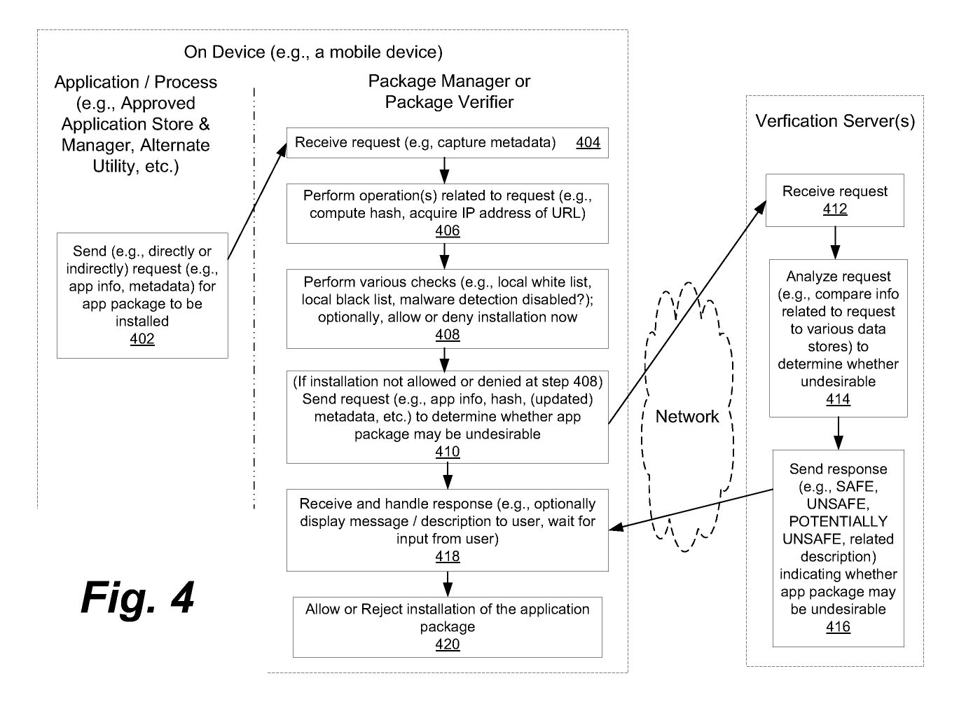

FIG. 4 depicts a flow diagram that shows example steps in a method to protect users from undesirable content, for example, on an open platform, in accordance with one or more embodiments of the present disclosure. At step 402, an application and/or process may send a request to a package manager and/or package verifier to indicate that an application should be installed. The application and/or process may be, for example, an approved application store and/or manager or an alternate utility used to search for, browse and/or download applications. The request may be send directly or indirectly from the application and/or process to the package manager and/or package verifier. For example, as shown by the example of FIG. 2, an approved application store and/or manager 208 may send a request directly to the package manager 210. As another example, an alternate utility 214 may communicate with a download manager service 216 and/or a package installer service 218 to send a request to the package manager 210. The request may include various pieces of information, for example, information about the application package (e.g., a hash or other unique identifier) and various pieces of metadata. The metadata may include information such as the download or source URL, the name of the application package, and optionally, various other types of metadata as explained herein.

FIG. 4 may depict the package manager and/or the package verifier as performing one or more steps and/or routines (e.g., steps 404, 406, 408, 410, 418, 420). It should be understood that in various embodiments of the present disclosure, various of these and related steps may be performed in the package manager, or in the package verifier or parts of these steps may be performed in one or the other of these modules.

At step 404, the package manager and/or the package verifier may receive the installation request. At step 406, the package manager and/or the package verifier may perform one or more operations related to the request. For example, the package manager and/or the package verifier may compute a hash (or other unique identifier) of the application package. As another example, package manager and/or the package verifier may acquire the IP address of one or more URLs, for example, by performing a DNS lookup. At step 408, the package manager and/or the package verifier may perform various checks related to the request and/or related to various options and/or settings related to the verification feature. For example, the package manager and/or the package verifier may determine whether the user has accepted and/or confirmed use of the verification feature (e.g., via a terms of service or other dialog). If the user has not accepted and/or confirmed, the application may be allowed to install (e.g., a package verifier may communicate a “SAFE” or “ALLOW” message to the package manager). As another example, the package manager and/or the package verifier may determine whether the user has disabled (e.g., via a settings page) the verification feature, for example, disabling the feature for the entire device or disabling the feature for the immediate application or group of applications. If the user has disabled the verification feature, the application may be allowed to install (e.g., a package verifier may communicate a “SAFE” or “ALLOW” message to the package manager). As another example check, the package manager and/or the package verifier may check whether the immediate application is currently in the process of being installed, and if so, it may allow the installation. As another example check, the package manager and/or the package verifier may check whether the device has network connectivity, and if it does not, it may allow the installation.

As another example check that may be performed at step 408, the package manager and/or the package verifier may check whether various pieces of metadata related to the application package and/or the request match information stored locally in one or more white lists and/or black lists. If a particular piece of metadata matches information in a white list, the application may be allowed to install (e.g., a package verifier may communicate a “SAFE” or “ALLOW” message to the package manager). If a particular piece of metadata matches information in a black list, the application may be prevented from installing (e.g., a package verifier may communicate an “UNSAFE” or “DON′T_ALLOW” message to the package manager).

At step 410, if the installation of the application was not already allowed or denied, for example, by the checks performed at step 408, the package manager and/or the package verifier may formulate and/or communicate a request to a verification server (e.g., an off-device or remote server) to determine whether the application package may be undesirable, for example, because it may include malware. The request may be communicated via an HTTP or HTTPS connection (e.g., to a specific URL or address). The request may include various pieces of information, for example, information related to the application package (e.g., a hash, the package name, the size of the package, etc.), information related to the source of the application package (e.g., the download or source URL, the download IP address, etc.), information related to the device (e.g., device and/or OS versions) and/or information related to the user of the device.

At step 412, the verification server may receive the verification request. At step 414, the verification serer may analyze the request to determine whether the application and/or application package may be undesirable (e.g., because it may include malware). For example, the verification server may compare information related to the request (e.g., the hash, the source URL, etc.) to information included in various data stores maintained by the verification server. At step 416, the verification server may send a response back to the device, where the response may indicate whether the application and/or application package may be undesirable (e.g., because it may include malware). For example, the response may include various messages such as “SAFE,” if the application is safe to install, “UNSAFE” if the application is not safe to install, and “POTENTIALLY UNSAFE.” The request may also include a description that explains why the application may or may not be safe. The request may also include various other types of information such as a title of the application (e.g., if the title was unable to be extracted by the mobile device) and/or a URL that the user may click for more information about why the application may be unsafe to install.

At step 418, package manager and/or the package verifier (e.g., in a device) may receive and handle the response. The package manager and/or the package verifier may take various actions based on the response. For example, if the response includes a “SAFE” message, the application may be allowed to install, e.g., a package verifier may communicate a “SAFE” or “ALLOW” message to the package manager and the package manager may install the application (step 420). As another example, if the response includes an “UNSAFE” message, the application may be prevented from installing, e.g., a package verifier may communicate an “UNSAFE” or “DON′T_ALLOW” message to the package manager and the package manager may exit or reject installation (step 420). In this example, at step 418, the package manager and/or the package verifier may cause a window and/or message to display on the screen of the device, for example, to notify the user that the application package was not installed (e.g., “Installation Failed”). As another example, if the response includes a “POTENTIALLY UNSAFE” message, the application may be prevented (e.g., temporarily) from installing. The package manager and/or the package verifier may cause a window and/or message to display on the screen of the device that warns the user that the application may be unsafe to install. The window and/or message may include a description explaining why the application may be unsafe to install. The window may include one or more buttons or the like that allow a user to abort the installation or continue the installation. As one example, once a user indicates the decision to abort or continue, the package verifier may communicate an ALLOW or DON′T_ALLOW message to the package manager accordingly, and the package manager may take the appropriate action (step 420).

At step 418, if the verification server does not respond in time (e.g., a failure or a network timeout), the package verifier and/or package manager may proceed with the installation of an application, for example, the package verifier may communicate an ALLOW message to the package manager.

It should be understood that, in situations where the systems, methods, routines and/or techniques described herein may collect or make use of information about a user, a developer and/or a related device, users and/or developers may be provided with one or more opportunities to control whether programs or features collect or make use of such information. Examples of information may include information about a user's social network, social actions or activities, profession, a user's preferences, or a user's current location. Other examples of information may include information about a developer's social network, social actions or activities, profession, a developer's preferences, or a developer's current location. Additionally, users and/or developers may be provided with one or more opportunities to control whether and/or how to receive content (e.g., applications) from content servers. Additionally, certain data may be treated in one or more ways before it is stored or used, so that personally identifiable information is removed. For example, a user's and/or developer's identity may be treated so that no (or limited) personally identifiable information can be determined for the user and/or the user's device. For example, a user's and/or developer's geographic location may be generalized where location information is obtained (such as to a city, ZIP code, or state level), so that a particular location of a user and/or developer cannot be determined. Thus, the user and/or developer may have control over how information is collected about the user and/or developer and used by a device and/or server.

Various embodiments of the present disclosure describe one or more systems, methods, routines and/or techniques to protect users from undesirable content, for example, on an open platform. One or more embodiments may include a method, for example, a method performed and/or executed on a computer, mobile device, smartphone or other computing device. The method may include receiving a first request to install an application package. The method may include receiving and/or capturing metadata (e.g., the URL of the source where the application was downloaded from) related to the application package. The method may include performing one or more operations to determine additional metadata (e.g., the IP address of the source where the application was downloaded from) related to the application package.

The method may include communicating a second request (e.g., including the metadata and/or the additional metadata) to a remote server, such that the remote server can determine whether the application package may be undesirable (e.g., because it may contain malware). The method may include receiving a response from the remote server, wherein the response may indicate whether the application package may be undesirable (e.g., because it may contain malware). The response from the remote server may include a message that indicates one of the following: the application is safe to install, the application is unsafe to install, the application is potentially unsafe to install. The method may include initiating installation of the application package, for example, if the application package is determined to be safe and/or has been accepted and/or authorized by a user. The application package may be prevented from installing if the application package is determined to be unsafe and/or was not accepted and/or authorized by a user. The method may include displaying, by the computing the message (included as part of the response) to a user. The method may include receiving input from a user that indicates whether the application package is acceptable and should be installed. The user may have been prompted to input a choice regarding whether or not to install the application, for example, if the application package was determined to be potentially unsafe.

In some embodiments, various steps of the method may be performed by a process or routine that is part of an approved application store and/or manager, for example, the step of communicating the second request to the remote server, the step of receiving the response from the remote server and the step of initiating installation of the application package. In some embodiments, various steps of the method may be performed by a process or routine that is part of the operating system of the computing device, for example, the step of communicating the second request to the remote server, the step of receiving the response from the remote server and the step of initiating installation of the application package.

One or more embodiments may include a method, for example, a method performed and/or executed on a computer, mobile device, smartphone or other computing device. The method may include receiving a first request to install an application package. The method may include receiving and/or capturing metadata related to the application package. The method may include comparing information about the application package (e.g., including the metadata) to information in one or more white lists and/or black lists stored locally on the computing device. The one or more white lists may indicate application packages that are safe to install, and the one or more black lists may indicate application packages that unsafe to install. The method may include communicating a second request (e.g., including the metadata) to a remote server, for example, if the information about the application package does not match information in the one or more white lists or the one or more black lists. The remote server may be adapted to determine whether the application package may be undesirable (e.g., because it may contain malware). The method may include receiving a response from the remote server, where the response may indicate whether the application package may be undesirable (e.g., because it may contain malware). The method may include initiating installation of the application package, for example, if the application package is determined to be safe and/or has been accepted and/or authorized by a user. The application package may be prevented from installing, for example, if the application package is determined to be unsafe and/or was not accepted and/or authorized by a user.

In some embodiments, various steps of the method may be performed by a process or routine that is part of an approved application store and/or manager, for example, the step of comparing information about the application package to information in one or more white lists and/or black lists or the step of communicating the second request to the remote server. In some embodiments, various steps of the method may be performed by a process or routine that is part of the operating system of the computing device, for example, the step of comparing information about the application package to information in one or more white lists and/or black lists or the step of communicating the second request to the remote server.

One or more embodiments of the present disclosure describe a computing device that may include one or more memory units that store computer code and one or more processor units coupled to the one or more memory units. The one or more processor units may execute the computer code stored in the one or more memory units to adapt the computing device to receive a first request to install an application package. The computing device may be further adapted to communicate a second request to a remote server, for example, such that the remote server can determine whether the application package may be undesirable (e.g., because it may contain malware). The computing device may be further adapted to receive a response from the remote server. The response may indicate whether the application package may be undesirable (e.g., because it may contain malware). The response from the remote server may include a message that indicates one of the following: the application is safe to install, the application is unsafe to install, the application is potentially unsafe to install.

The computing device may be further adapted to initiate installation of the application package, for example, if the application package is determined to be safe and/or has been accepted and/or authorized by a user. The application package may be prevented from installing, for example, if the application package is determined to be unsafe and/or was not accepted and/or authorized by a user. The computing device may be further adapted to receive and/or capture metadata (e.g., the URL of the source where the application was downloaded from) related to the application package. The computing device may be further adapted to receive input from a user that indicates whether the application package is acceptable and should be installed. The user may have been prompted to input a choice regarding whether or not to install the application, for example, if the application package was determined to be potentially unsafe.

In some embodiments, the majority of the computer code executed by one or more processor units may be part of the operating system of the computing device. In some embodiments, the majority of the computer code executed by one or more processor units may be part of an approved application store and/or manager installed on the computing device.

The methods, routines and solutions of the present disclosure, including the example methods and routines illustrated in the flowcharts and block diagrams of the different depicted embodiments may be implemented as software executed by a data processing system that is programmed such that the data processing system is adapted to perform and/or execute the methods, routines, techniques and solutions described herein. Each block or symbol in a block diagram or flowchart diagram referenced herein may represent a module, segment or portion of computer usable or readable program code which comprises one or more executable instructions for implementing, by one or more data processing systems, the specified function or functions. In some alternative implementations of the present disclosure, the function or functions illustrated in the blocks or symbols of a block diagram or flowchart may occur out of the order noted in the figures. For example in some cases two blocks or symbols shown in succession may be executed substantially concurrently or the blocks may sometimes be executed in the reverse order depending upon the functionality involved. Part or all of the computer code may be loaded into the memory of a data processing system before the data processing system executes the code.

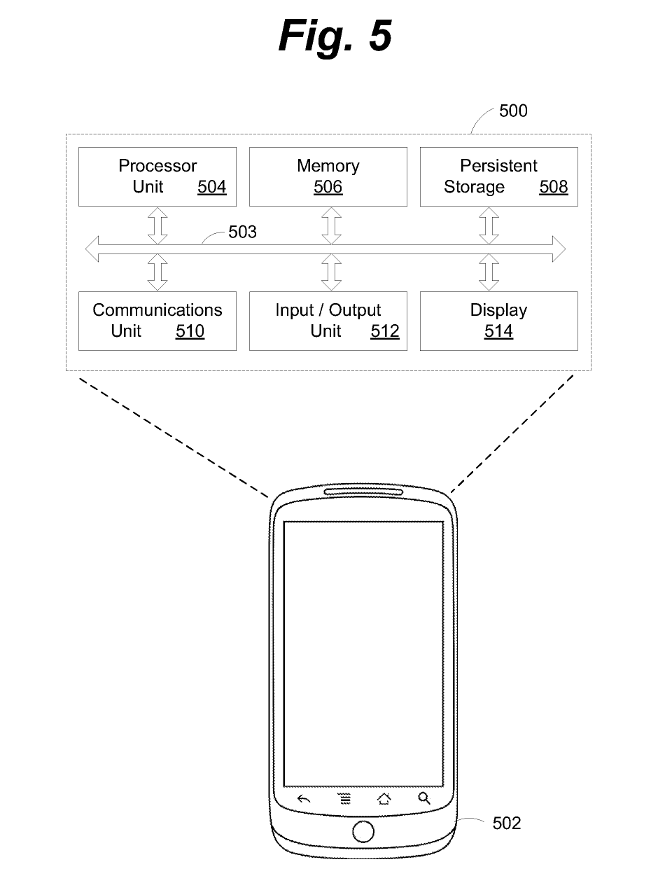

FIG. 5 depicts a block diagram of an example data processing system 500 that may be included within a mobile device 502 or smartphone, according to one or more embodiments of the present disclosure. The data processing system 500 may be used to execute, either partially or wholly, one or more of the methods, routines and/or solutions of the present disclosure. In some embodiments of the present disclosure, more than one data processing system, for example data processing systems 500, may be used to implement the methods, routines, techniques and/or solutions described herein. In the example of FIG. 5, data processing system 500 may include a communications fabric 503 which provides communications between components, for example a processor unit 504, a memory 506, a persistent storage 508, a communications unit 510, an input/output (I/O) unit 512 and a display 514. A bus system may be used to implement communications fabric 503 and may be comprised of one or more buses such as a system bus or an input/output bus. The bus system may be implemented using any suitable type of architecture that provides for a transfer of data between different components or devices attached to the bus system.

Processor unit 504 may serve to execute instructions (for example, a software program, an application, SDK code, native OS code and the like) that may be loaded into the data processing system 500, for example, into memory 506. Processor unit 504 may be a set of one or more processors or may be a multiprocessor core depending on the particular implementation. Processor unit 504 may be implemented using one or more heterogeneous processor systems in which a main processor is present with secondary processors on a single chip. As another illustrative example, processor unit 504 may be a symmetric multi-processor system containing multiple processors of the same type.

Memory 506 may be, for example, a random access memory or any other suitable volatile or nonvolatile storage device. Memory 506 may include one or more layers of cache memory. Persistent storage 508 may take various forms depending on the particular implementation. For example, persistent storage 508 may contain one or more components or devices. For example, persistent storage 508 may be a hard drive, a solid-state drive, a flash memory or some combination of the above.

Instructions for an operating system may be located on persistent storage 508. In one specific embodiment, the operating system may be some version of a number of known operating systems for mobile devices or smartphones (e.g, Android, iOS, etc.). Instructions for applications and/or programs may also be located on persistent storage 508. These instructions may be loaded into memory 506 for execution by processor unit 504. For example, the methods and/or processes of the different embodiments described in this disclosure may be performed by processor unit 504 using computer implemented instructions which may be loaded into a memory such as memory 506. These instructions are referred to as program code, computer usable program code or computer readable program code that may be read and executed by a processor in processor unit 504.

Display 514 may provide a mechanism to display information to a user, for example, via a LCD or LED screen or monitor, or other type of display. It should be understood, throughout this disclosure, that the term “display” may be used in a flexible manner to refer to either a physical display such as a physical screen, or to the image that a user sees on the screen of a physical device. Input/output (I/O) unit 512 allows for input and output of data with other devices that may be connected to data processing system 500. Input/output devices can be coupled to the system either directly or through intervening I/O controllers.

Communications unit 510 may provide for communications with other data processing systems or devices, for example, via one or more networks. Communications unit 510 may be a network interface card. Communications unit 510 may provide communications through the use of wired and/or wireless communications links. In some embodiments, the communications unit may include circuitry that is designed and/or adapted to communicate according to various wireless communication standards, for example, cellular standards, WIFI standards, BlueTooth standards and the like.

The different components illustrated for data processing system 500 are not meant to provide architectural limitations to the manner in which different embodiments may be implemented. The different illustrative embodiments may be implemented in a data processing system including components in addition to or in place of those illustrated for data processing system 500. Other components shown in FIG. 5 can be varied from the illustrative examples shown.

The description of the different advantageous embodiments has been presented for purposes of illustration and the description and is not intended to be exhaustive or limited to the embodiments in the form disclosed. Many modifications and variations will be apparent to those of ordinary skill in the art. Further different advantageous embodiments may provide different advantages as compared to other advantageous embodiments. The embodiment or embodiments selected are chosen and described in order to best explain the principles of the embodiments of the practical application and to enable others of ordinary skill in the art to understand the disclosure for various embodiments with various modifications as are suited to the particular use contemplated.

1. A method comprising:
receiving, by a computing device, a first request to install an application package;
receiving, by the computing device, metadata related to the application package;
communicating, by the computing device, a second request to a remote server, such that the remote server can determine whether the application package may be undesirable, wherein the second request includes the metadata;
receiving, by the computing device, a response from the remote server, wherein the response indicates whether the application package may be undesirable; and
initiating, by the computing device, installation of the application package if the application package is determined to be safe or acceptable.

2. The method of claim 1, further comprising performing one or more operations, by the computing device, to determine additional metadata related to the application package, wherein the second request includes the additional metadata.

3. The method of claim 1, wherein the metadata includes the URL of the source where the application was downloaded from.

4. The method of claim 2, wherein the additional metadata includes the IP address of the source where the application was downloaded from.

5. The method of claim 1, wherein the response from the remote server includes a message that indicates one of the following: the application is safe to install, the application is unsafe to install, the application is potentially unsafe to install.

6. The method of claim 5, further comprising displaying, by the computing device, the message to a user.

7. The method of claim 5, further comprising receiving, by the computing device, input from a user that indicates whether the application package is acceptable and should be installed.

8. The method of claim 1, wherein the step of communicating the second request to the remote server and the step of receiving the response from the remote server and the step of initiating installation of the application package are each performed by a process or routine that is part of an approved application store or manager.

9. A method comprising:
receiving, by a computing device, a first request to install an application package;
comparing, by the computing device, information about the application package to information in one or more white lists and one or more black lists stored locally on the computing device,
wherein the one or more white lists indicate application packages that are safe to install, and the one or more black lists indicate application packages that unsafe to install;
communicating, by the computing device, a second request to a remote server if the information about the application package does not match information in the one or more white lists or the one or more black lists,
wherein the remote server is adapted to determine whether the application package may be undesirable.

10. The method of claim 9, further comprising receiving, by the computing device, metadata related to the application package, wherein comparing information about the application package to one or more white lists and one or more black lists includes comparing the metadata to information in the one or more white lists and the one or more black lists.

11. The method of claim 9, further comprising receiving, by the computing device, metadata related to the application package, wherein the second request includes the metadata.

12. The method of claim 9, wherein the step of comparing information about the application package to information in one or more white lists and one or more black lists is performed by the operating system of the computing device.

13. The method of claim 9, wherein the step of communicating the second request to the remote server is performed by the operating system of the computing device.

14. The method of claim 9, further comprising:
receiving, by the computing device, a response from the remote server, wherein the response indicates whether the application package may be undesirable; and
initiating, by the computing device, installation of the application package if the application package is determined to be safe or acceptable.

15. The method of claim 10, wherein the step of receiving the response from the remote server and the step of initiating installation of the application package are each performed by the operating system of the computing device.

16. A computing device comprising:
one or more memory units that store computer code; and
one or more processor units coupled to the one or more memory units, wherein the one or more processor units execute the computer code stored in the one or more memory units to adapt the computing device to:
receive a first request to install an application package;
communicate a second request to a remote server, such that the remote server can determine whether the application package may be undesirable;
receive a response from the remote server, wherein the response indicates whether the application package may be undesirable; and
initiate installation of the application package if the application package is determined to be safe or acceptable.

17. The method of claim 16, wherein the computing device is further adapted to receive metadata related to the application package, wherein the second request includes the metadata.

18. The method of claim 17, wherein the metadata includes the URL of the source where the application was downloaded from.

19. The method of claim 18, wherein the response from the remote server includes a message that indicates one of the following: the application is safe to install, the application is unsafe to install, the application is potentially unsafe to install.

20. The method of claim 18, wherein the computing device is further adapted to receive input from a user that indicates whether the application package is acceptable and should be installed.

21. The method of claim 18, wherein the majority of the computer code is part of the operating system of the computing device.

22. The method of claim 18, wherein the majority of the computer code is part of an approved application store or manager installed on the computing device.
